(19) United States
(12) Patent Application Publication
(10) Pub. No.: US 2022/0292342 A1
(43) Pub. Date: Sep. 15, 2022

(54) Communication Efficient Federated/Distributed Learning of Neural Networks

(71) Applicant: VMware, Inc., Palo Alto, CA (US)

(72) Inventors: Yaniv Ben-Itzhak, Afek (IL); Shay Vargaftik, Nazareth-Illit (IL)

(21) Appl. No.: 17/199,157

(22) Filed: Mar. 11, 2021

(51) Int. Cl. G06N 3/08; G06N 3/04; H04L 29/08; G06F 9/48

(52) U.S. Cl. CPC G06N 3/08; G06N 3/0454; H04L 67/04; G06F 9/4856

(57) ABSTRACT

In one set of embodiments, a client can receive from a server a copy of a neural network from a server including N layers. The client can further provide one or more data instances as input to the copy, the one or more data instances being part of a local training data set residing on the client, compute a client gradient comprising gradient values for the N layers, determine a partial client gradient comprising gradient values for a first K out of the N layers, and determine an output of a K-th layer of the copy, the output being a result of processing performed by the first K layers on the one or more data instances. The client can then transmit the partial client gradient and the output of the K-th layer to the server.

### BACKGROUND

Federated learning is a machine learning (ML) paradigm in which multiple distributed clients—under the direction of a central server known as a parameter server—collaboratively train an ML model on training datasets that locally reside on, and are private to, those clients. For example, in the scenario where the ML model is a neural network, federated learning typically proceeds as follows: (1) the parameter server transmits a copy of the neural network comprising the neural network's current parameter values to a subset of the clients; (2) each client in the subset provides one or more data instances in its local training dataset as input to its received neural network (resulting in one or more corresponding results/predictions), computes a gradient for the neural network (referred to herein as a “client gradient”) based on the inputted data instances and outputted results/predictions according to a loss function, and transmits the client gradient to the parameter server; (3) the parameter server aggregates the client gradients into a global gradient and uses the global gradient to update the parameters of the neural network (i.e., performs an optimization step); and (4) steps (1) through (3) are repeated until a termination criterion is met.

One issue with this conventional federated learning process is that the client gradients transmitted from the clients to the parameter server are each proportional in size to the number of neural network parameters, which can be very high in many types of neural networks. For example, the well-known ResNet-50 convolutional neural network comprises more than 23 million parameters. Thus, using federated learning to train neural networks can incur a significant amount of communication overhead between the clients and the parameter server in order to exchange parameter update (e.g., gradient) information. This can result in communication bottlenecks in many real-world federated learning deployments, such as deployments in which the clients are edge computing devices (e.g., smartphones, tablets, IoT (Internet of Things) devices, etc.) operating under network connectivity and/or bandwidth constraints.

### BRIEF DESCRIPTION OF THE DRAWINGS

FIG. 1 depicts a first system implementing conventional federated learning of a neural network.

FIG. 2 depicts an example neural network.

FIG. 3 depicts a second system implementing communication efficient federated learning of a neural network according to certain embodiments.

FIG. 4 depicts a communication efficient federated learning workflow according to certain embodiments.

### DETAILED DESCRIPTION

In the following description, for purposes of explanation, numerous examples and details are set forth in order to provide an understanding of various embodiments. It will be evident, however, to one skilled in the art that certain embodiments can be practiced without some of these details or can be practiced with modifications or equivalents thereof.

### 1. Overview

The present disclosure is directed to techniques for implementing federated learning of a neural network—or in other words, training a neural network using federated learning—in a communication efficient manner. In one set of embodiments, these techniques include determining, by each client participating in a training round of the federated learning process, a partial client gradient comprising gradient values for the first K layers of the neural network, where the neural network comprises N total layers and where K is less than N. The client can transmit this partial client gradient, along with the output of the K-th layer of the neural network (which is generated in response to input training data instances X) and the training labels for X (i.e., Y) (or alternatively a loss vector instead of Y) to the parameter server.

Upon receiving these data items, the parameter server can perform a forward pass of the output of the K-th layer through layers K+1 to N of the neural network, compute, for each participating client, a gradient for layers K+1 to N based on the results of the forward pass and Y, and combine the gradient for layers K+1 to N with the client's partial client gradient in order to determine a complete client gradient for that client. The parameter server can then compute a global gradient for the neural network by aggregating the complete client gradients and update the parameters of the neural network in accordance with the global gradient. These and other aspects are described in further detail below.

### 2. Conventional Federated Learning and Solution Description

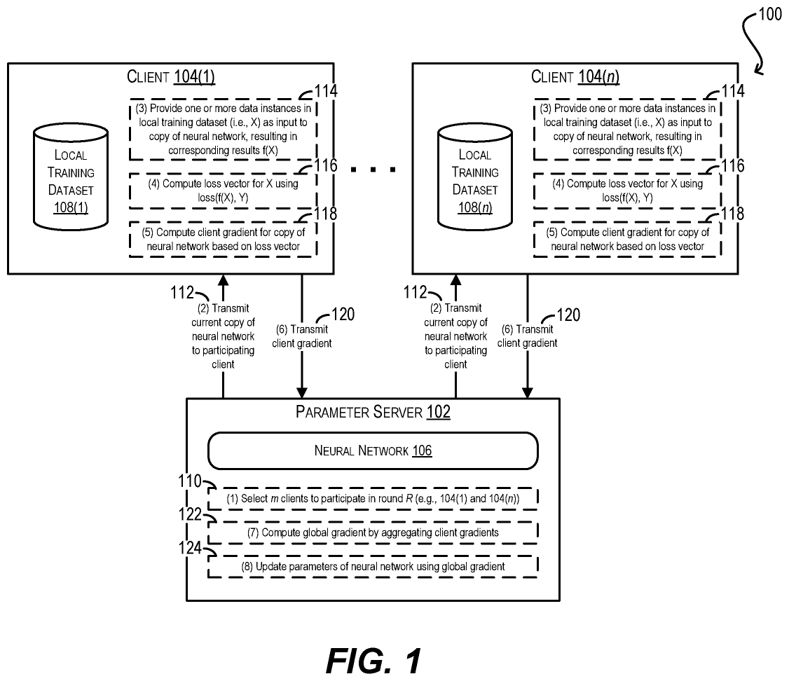

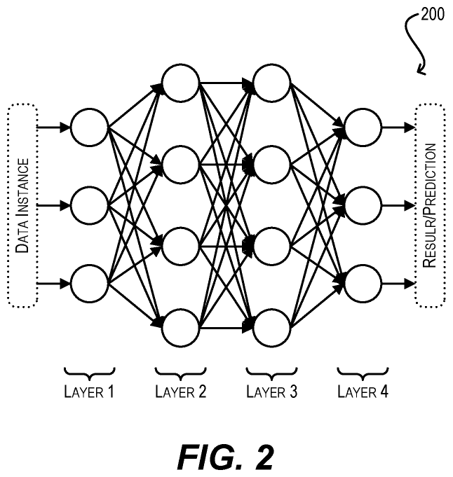

FIG. 1 depicts a system 100 comprising a parameter server 102 and a pool of clients 104(1)-(n) that implement conventional federated learning of a neural network 106 (shown via steps (1)-(8)/reference numerals 110-124). A neural network is a type of ML model that includes a collection of nodes, also known as neurons, that are organized into layers and are interconnected via directed edges. For instance, FIG. 2 depicts an example representation 200 of neural network 106 that includes a total of fourteen nodes and four layers 1-4. The nodes/edges are associated with parameters (e.g., weights and biases, not shown) that control how a data instance (which is provided as input to the neural network via the first layer) is processed to generate a result/prediction (which is output by the last layer). These parameters are the aspects of the neural network that are adjusted via training in order to optimize the performance of the neural network in generating correct results/predictions.

Conventional federated learning proceeds according to a series of training rounds and FIG. 1 illustrates the steps performed by system 100 as part of a current training round R. Starting with steps (1) and (2) (reference numerals 110 and 112), parameter server 102 selects m clients to participate in round R and transmits a copy of neural network 106 to each of these m (i.e., participating) clients. For purposes of illustration, parameter server 102 transmits this copy to two clients 104(1) and 104(n) in FIG. 1, but in practice m can be any number between 1 and n. The copy of neural network 106 can include current values for all of the parameters of neural network 106 as determined via prior rounds 1 to R−1.

At step (3) (reference numeral 114), client 104(1)/104(n)—which includes a local training dataset 108 that resides on and is private to that client—provides one or more data instances in its local training dataset, collectively denoted by the matrix X, as input to its received copy of neural network 106. Each of these data instances comprises a set of attributes and a training label indicating a correct result that should be generated by neural network 106 upon receiving and processing the data instance's attributes. The outcome of step (3) is one or more results/predictions corresponding to X, collectively denoted by f(X).

Client 104(1)/104(n) then computes a loss vector (sometimes referred to as an error) for X using a loss function that takes f(X) and the training labels of X (denoted by the vector Y) as input (step (4); reference numeral 116), uses backpropagation to compute a gradient (i.e., “client gradient”) for the entirety of the copy of neural network 106 based on the loss vector (step (5); reference numeral 118), and transmits the client gradient to parameter server 102 (step (6); reference numeral 120). Generally speaking, the client gradient indicates how much the output of the client's copy of neural network 106 changes in response to changes in the network's parameters in accordance with the computed loss vector.

At step (7) (reference numeral 122), parameter server 102 receives the client gradients from clients 104(1) and 104(n) and computes a global gradient by aggregating the received client gradients. The global gradient indicates how much the output of neural network 106 changes in response to changes in the network's parameters in accordance with the losses determined at each participating client. Finally, at step (8) (reference numeral 124), parameter server 102 employs a gradient-based optimization technique to update the parameters of neural network 106 based on the global gradient and current round R ends. Steps (1)-(8) can subsequently repeat for additional rounds R+1, R+2, etc. until a termination criterion is met that ends the training of neural network 106. This termination criterion may be, e.g., a lower bound on the absolute size of the global gradient, accuracy threshold, or a number of rounds threshold.

As noted in the Background section, an issue with the conventional federated learning process shown in FIG. 1 is that each client gradient transmitted to parameter server 102 at step (6) is proportional in size to the number of parameters in neural network 106, which can be very high (e.g., on the order of thousands or millions of parameters). As a result, the network bandwidth needed between clients 104(1)-(n) and parameter server 102 in order to carry out the federated learning process may also be very high, which can be problematic for deployments where the clients are limited by network connectivity/bandwidth constraints.

One way to mitigate this issue is for each participating client to compress its client gradient via an aggressive (e.g., lossy) compression algorithm prior to transmitting the client gradient to parameter server 102. However, the use of such aggressive compression algorithms can add a significant amount of CPU overhead to the clients (which may be limited by compute and/or power constraints, in addition to network constraints) and can potentially delay model convergence and reduce model accuracy.

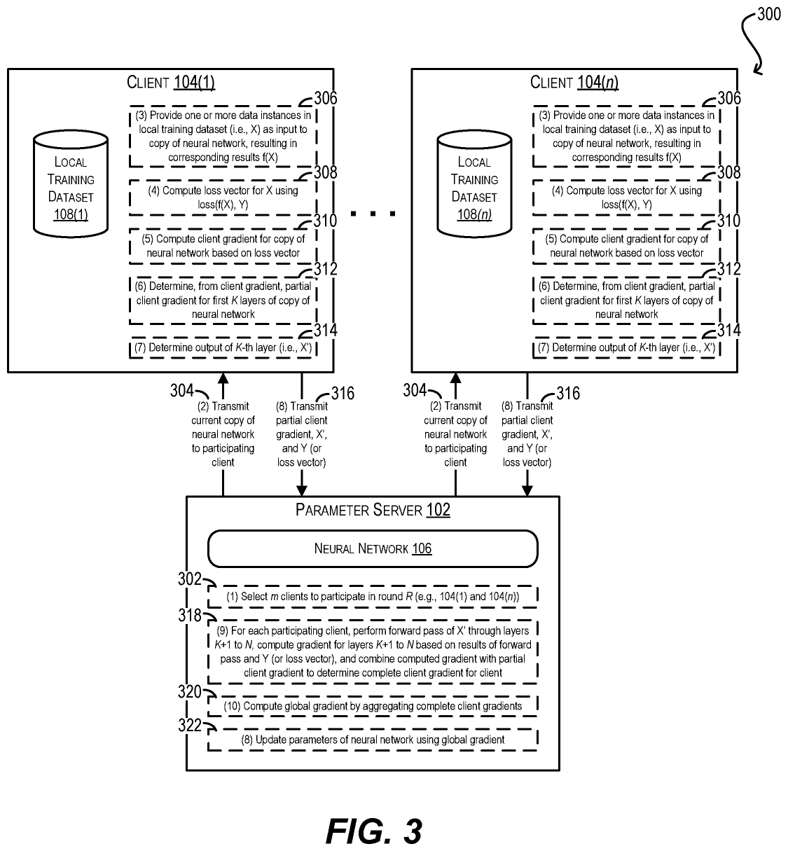

To address the foregoing and other similar problems, FIG. 3 depicts a version of system 100 of FIG. 1 (i.e., system 300) in which parameter server 102 and clients 104(1)-(n) are configured to execute a novel federated learning process for training neural network 106 in a communication efficient manner (shown via steps (1)-(11)/reference numerals 302-322) according to certain embodiments.

Steps (1)-(5) (reference numerals 302-310) of FIG. 3 are largely similar to steps (1)-(5) of FIG. 1. At step (6) (reference numeral 312), client 104(1)/104(n) can determine, from the client gradient computed at step (5), a partial client gradient that includes gradient values for solely the first K layers of its copy of neural network 106, where K is a configurable number between 1 and N−1 and where N is the total number of layers in neural network 106. This partial client gradient is different from the client gradient because the client gradient includes gradient values for all N layers of the copy of neural network 106.

Client 104(1)/104(n) can further determine the output of the K-th layer of its copy of neural network 106, which can be understood as the result of processing the data instances inputted at step (3) (i.e., matrix X) via layers 1 through K (step (7); reference numeral 314). This output of the K-th layer is denoted by X′. By way of example, assume neural network 106 has the structure shown in FIG. 2 and K=2. In this scenario, client 104(1)/104(n) can compute a partial client gradient that includes gradient values for solely layers 1 and 2 shown in FIG. 2, and can determine X′ as the output of layer 2 (which is the result of data instances X passing through, or in other words being processed by, layers 1 and 2). Client 104(1)/104(n) can then transmit the partial client gradient, X′, and the training labels of X (i.e., Y) to parameter server 102 (or alternatively the loss vector computed from f(X) using the loss function) (step (8); reference numeral 316).

At step (9) (reference numeral 318), parameter server 102 can receive these three data items from clients 104(1) and 104(n) and, for each of these clients, perform a forward pass of X′ through layers K+1 to N, use backpropagation to compute a gradient for layers K+1 to N (or in other words, the last K-N layers) of neural network 106 based on the results of the forward pass and Y (or the loss vector), and combine this gradient with the partial client gradient in order to determine a complete client gradient for that client. Finally, parameter server 102 can compute a global gradient by aggregating the complete client gradients (step (10); reference numeral 320) and employ a gradient-based optimization technique such as stochastic gradient descent (SGD) to update the parameters of neural network 106 based on the global gradient (step (11); reference numeral 322), thereby ending current round R. As with the process shown in FIG. 1, steps (1)-(11) can subsequently repeat for additional rounds R+1, R+2, etc. until a termination criterion is met that ends the training of neural network 106.

With the federated learning approach shown in FIG. 3, a number of advantages are realized over conventional federated learning. For example, because each participating client only transmits a partial client gradient for the first K layers of neural network 106 to parameter server 102 in each round (rather than the complete client gradient for all N layers), the amount of data that is sent over the network can be significantly less than the conventional approach, resulting in reduced communication overhead and thus a reduction, or elimination, of communication bottlenecks between clients 104(1)-(n) and parameter server 102. This is achieved without requiring compression of the transmitted data, which avoids the pitfalls of aggressive compression techniques (e.g., increased convergence times and reduced accuracy). Although the approach shown in FIG. 3 requires each participating client to also send X′ and Y (or the loss vector) to parameter server 102, these data items will often be much smaller in size than the complete client gradient for all N layers.

Further, this approach is compatible with any type of loss function, any type of backpropagation architecture, and any type of loss-based optimizer. Accordingly, it can be flexibly incorporated into most existing federated learning systems.

It should be appreciated that FIGS. 1-3 are illustrative and not intended to limit embodiments of the present disclosure. For example, regarding step (8) of FIG. 3, in some embodiments client 104(1)/104(n) can compress its partial client gradient, X′, and Y prior to sending these data items to parameter server 102, thereby further reducing the communication overhead of the process. In response, parameter server 102 can decompress the data items upon receipt. Similarly, regarding step (2) of FIG. 3, in some embodiments parameter server 102 can compress the copy of neural network 106 prior to sending it to clients 104(1) and 104(n), and in response client 104(1)/104(n) can decompress the copy upon receipt. The compression techniques used in these embodiments can be lossless and/or lossy and computationally inexpensive to limit any negative impacts arising out of the compression and decompression steps.

In addition, although the foregoing description focuses on the use case of federated learning, the same or similar techniques can be used to implement communication efficient distributed learning. Distributed learning is largely similar to federated learning but does not require the local training datasets of clients 104(1)-(n) to be private to the respective clients.

In addition, although parameter server 102 is depicted in FIGS. 1 and 3 as a singular server/computer system, in some embodiments parameter server 102 may be implemented as a cluster of servers/computer systems for enhanced performance, reliability, and/or other reasons. One of ordinary skill in the art will recognize other variations, modifications, and alternatives.

### 3. Communication Efficient Federated Learning Workflow

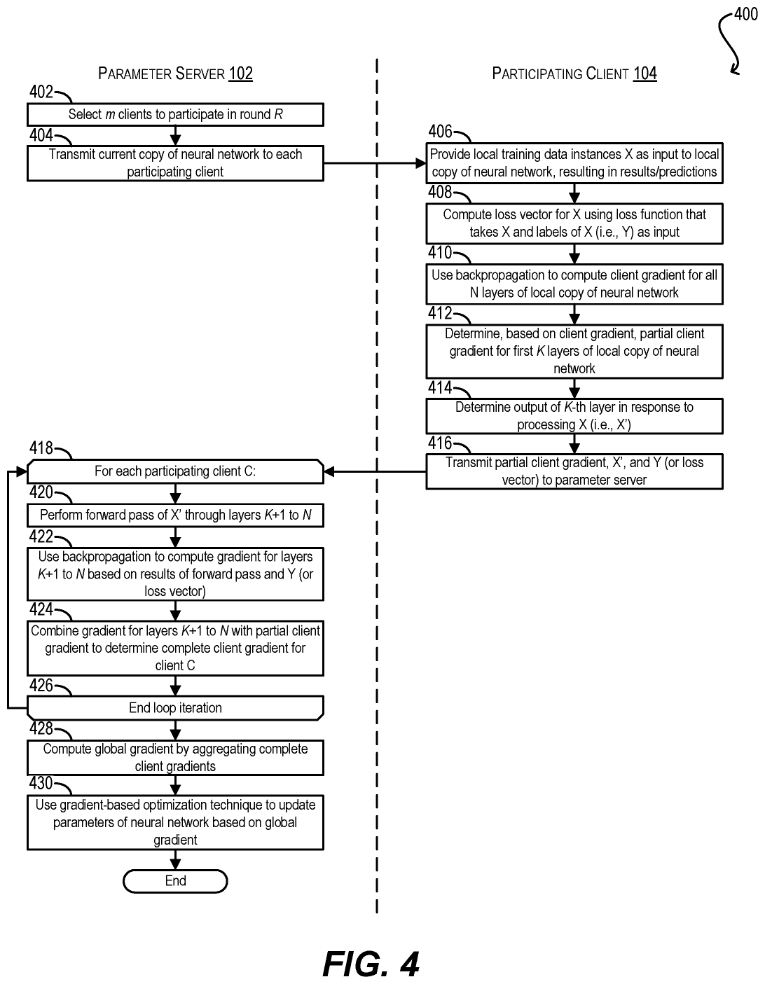

FIG. 4 depicts, in the form a flowchart 400, the processing performed parameter server 102 and clients 104(1)-(n) of FIG. 3 for carrying out communication efficient federated learning of neural network 106 according to certain embodiments. As with FIG. 3, the steps shown in flowchart 400 pertain to the actions executed by these entities within the context of a single training round R.

At blocks 402 and 404, parameter server 102 can select m clients to participate in round R and can transmit a current copy of neural network 106 to each participating client 104.

At block 406, each participating client 104 can provide one or more data instances in its local training dataset 108 (i.e., X) as input to its received copy of neural network 106, resulting in one or more corresponding results/predictions. The client can further compute a loss vector for X using a loss function that takes X and Y (i.e., the labels of X) as input (block 408) and use backpropagation to compute a client gradient for all N layers of its copy of neural network 106 based on the loss vector (block 410).

At blocks 412 and 414, the client can further determine, based on the client gradient computed at block 410, a partial client gradient corresponding to the first K layers of its copy of neural network 106 and determine the output of the K-th layer (i.e., X′) in response to processing X. The client can then transmit the partial client gradient, X′, and Y to parameter server 102 (block 416). In alternative embodiments, the client can transmit the loss vector computed at block 408 instead of Y.

Upon receiving these data items from all m participating clients, parameter server 102 can enter a loop for each participating client C (or alternatively process each client C in parallel) (block 418). Within this loop, parameter server 102 can perform a forward pass of X′ through layers K+1 to N of neural network 106 (or in other words, provide X′ as input to layer K+1 for processing through layers K+1 to N) (block 420) and use backpropagation to compute a gradient for layers K+1 to N (i.e., the last K-N layers) based on the results of the forward pass and Y (or the loss vector) received from client C (block 422). Parameter server 102 can further combine this gradient with the partial client gradient received from client C in order to determine a complete client gradient for C (block 424) and reach the end of the current loop iteration (block 426).

Finally, once parameter server 102 has processed all of the participating clients per loop 418, parameter server 102 can compute a global gradient by aggregating the complete client gradients determined at block 424 (block 428) and employ a gradient-based optimization technique such as SGD to update the parameters of neural network 106 based on the global gradient (block 430). Round R can subsequently end, and additional training rounds (or in other words, additional executions of flowchart 400) can be performed as needed until a termination criterion is satisfied.

Certain embodiments described herein can employ various computer-implemented operations involving data stored in computer systems. For example, these operations can require physical manipulation of physical quantities—usually, though not necessarily, these quantities take the form of electrical or magnetic signals, where they (or representations of them) are capable of being stored, transferred, combined, compared, or otherwise manipulated. Such manipulations are often referred to in terms such as producing, identifying, determining, comparing, etc. Any operations described herein that form part of one or more embodiments can be useful machine operations.

Further, one or more embodiments can relate to a device or an apparatus for performing the foregoing operations. The apparatus can be specially constructed for specific required purposes, or it can be a generic computer system comprising one or more general purpose processors (e.g., Intel or AMD x86 processors) selectively activated or configured by program code stored in the computer system. In particular, various generic computer systems may be used with computer programs written in accordance with the teachings herein, or it may be more convenient to construct a more specialized apparatus to perform the required operations. The various embodiments described herein can be practiced with other computer system configurations including handheld devices, microprocessor systems, microprocessor-based or programmable consumer electronics, minicomputers, mainframe computers, and the like.

Yet further, one or more embodiments can be implemented as one or more computer programs or as one or more computer program modules embodied in one or more non-transitory computer readable storage media. The term non-transitory computer readable storage medium refers to any data storage device that can store data which can thereafter be input to a computer system. The non-transitory computer readable media may be based on any existing or subsequently developed technology for embodying computer programs in a manner that enables them to be read by a computer system. Examples of non-transitory computer readable media include a hard drive, network attached storage (NAS), read-only memory, random-access memory, flash-based nonvolatile memory (e.g., a flash memory card or a solid state disk), a CD (Compact Disc) (e.g., CD-ROM, CD-R, CD-RW, etc.), a DVD (Digital Versatile Disc), a magnetic tape, and other optical and non-optical data storage devices. The non-transitory computer readable media can also be distributed over a network coupled computer system so that the computer readable code is stored and executed in a distributed fashion.

Finally, boundaries between various components, operations, and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations can be implemented as a combined structure or component. Similarly, structures and functionality presented as a single component can be implemented as separate components.

As used in the description herein and throughout the claims that follow, “a,” “an,” and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments along with examples of how aspects of particular embodiments may be implemented. These examples and embodiments should not be deemed to be the only embodiments and are presented to illustrate the flexibility and advantages of particular embodiments as defined by the following claims. Other arrangements, embodiments, implementations, and equivalents can be employed without departing from the scope hereof as defined by the claims.

What is claimed is:

1. A method comprising:
receiving, by a client, a copy of a neural network from a server, the neural network including N layers;
providing, by the client, one or more data instances as input to the copy of the neural network, the one or more data instances being part of a local training data set residing on the client;
computing, by the client, a client gradient comprising gradient values for the N layers;
determining, by the client from the client gradient, a partial client gradient comprising gradient values for a first K out of the N layers;
determining, by the client, an output of a K-th layer of the copy of the neural network, the output being a result of processing performed by the first K layers on the one or more data instances; and
transmitting, by the client, the partial client gradient and the output of the K-th layer to the server.

2. The method of claim 1 wherein the client further transmits one or more training labels associated with the one or more data instances to the server or a loss vector determined as a result of providing the one or more data instances as input to the copy of the neural network.

3. The method of claim 2 wherein upon receiving the partial client gradient, the output of the K-th layer, and the one or more training labels or the loss vector, the server performs a forward pass of the output of the K-th layer through a last K-N out of the N layers and uses backpropagation to compute a gradient comprising gradient values for the last K-N layers.

4. The method of claim 3 wherein the server further combines the gradient with the partial client gradient in order to determine the client gradient.

5. The method of claim 4 wherein, upon determining the client gradient and one or more other client gradients for one or more other clients, the server computes a global gradient by aggregating the client gradient with the one or more other client gradients and updates parameters of the neural network based on the global gradient.

6. The method of claim 1 wherein the client compresses the partial client gradient and the output of the K-th layer prior to transmitting the partial client gradient and the output of the K-th layer to the server.

7. The method of claim 1 wherein the server compresses the copy of the neural network prior to transmitting the copy to the client.

8. A non-transitory computer readable storage medium having stored thereon program code executable by a computer system, the program code causing the computer system to execute a method comprising:
receiving a copy of a neural network from a server, the neural network including N layers;
providing one or more data instances as input to the copy of the neural network, the one or more data instances being part of a local training data set residing on the computer system;
computing a client gradient comprising gradient values for the N layers;
determining, from the client gradient, a partial client gradient comprising gradient values for a first K out of the N layers;
determining an output of a K-th layer of the copy of the neural network, the output being a result of processing performed by the first K layers on the one or more data instances; and
transmitting the partial client gradient and the output of the K-th layer to the server.

9. The non-transitory computer readable storage medium of claim 8 wherein the computer system further transmits one or more training labels associated with the one or more data instances to the server or a loss vector determined as a result of providing the one or more data instances as input to the copy of the neural network.

10. The non-transitory computer readable storage medium of claim 9 wherein upon receiving the partial client gradient, the output of the K-th layer, and the one or more training labels or the loss vector, the server performs a forward pass of the output of the K-th layer through a last K-N out of the N layers and uses backpropagation to compute a gradient comprising gradient values for the last K-N N layers.

11. The non-transitory computer readable storage medium of claim 10 wherein the server further combines the gradient with the partial client gradient in order to determine the client gradient.

12. The non-transitory computer readable storage medium of claim 11 wherein, upon determining the client gradient and one or more other client gradients for one or more other computer systems, the server computes a global gradient by aggregating the client gradient with the one or more other client gradients and updates parameters of the neural network based on the global gradient.

13. The non-transitory computer readable storage medium of claim 8 wherein the computer system compresses the partial client gradient and the output of the K-th layer prior to transmitting the partial client gradient and the output of the K-th layer to the server.

14. The non-transitory computer readable storage medium of claim 8 wherein the server compresses the copy of the neural network prior to transmitting the copy to the computer system.

15. A computer system comprising:
a processor;
a storage component storing a local training dataset; and
a non-transitory computer readable medium having stored thereon program code that, when executed by the processor, causes the processor to:
receive a copy of a neural network from a server, the neural network including N layers;
provide one or more data instances as input to the copy of the neural network, the one or more data instances being part of the local training data set;
determine, from the client gradient, a partial client gradient comprising gradient values for a first K out of the N layers;
determine an output of a K-th layer of the copy of the neural network, the output being a result of processing performed by the first K layers on the one or more data instances; and
transmit the partial client gradient and the output of the K-th layer to the server.

16. The computer system of claim 15 wherein the processor further transmits one or more training labels associated with the one or more data instances to the server or a loss vector determined as a result of providing the one or more data instances as input to the copy of the neural network.

17. The computer system of claim 16 wherein upon receiving the partial client gradient, the output of the K-th layer, and the one or more training labels, the server performs a forward pass of the output of the K-th layer through a last K-N out of the N layers and uses backpropagation to compute a gradient comprising gradient values for the last K-N layers.

18. The computer system of claim 17 wherein the server further combines the gradient with the partial client gradient in order to determine the client gradient.

19. The computer system of claim 18 wherein, upon determining the client gradient and one or more other client gradients for one or more other computer systems, the server computes a global gradient by aggregating the client gradient with the one or more other client gradients and updates parameters of the neural network based on the global gradient.

20. The computer system of claim 15 wherein the processor compresses the partial client gradient and the output of the K-th layer prior to transmitting the partial client gradient and the output of the K-th layer to the server.

21. The computer system of claim 15 wherein the server compresses the copy of the neural network prior to transmitting the copy to the computer system.
